(19) United States
(12) Patent Application Publication
(10) Pub. No.: US 2009/0102442 A1
(43) Pub. Date: Apr. 23, 2009

(54) Power Supply Device for USB

(76) Inventor: Li-Chun Lai, Panciao City (TW)

Correspondence Address: HDLS Patent & Trademark Services, P.O. BOX 220746, CHANTILLY, VA, 20153-0746, US

(21) Appl. No.: 11/874,670

(22) Filed: Oct. 18, 2007

(51) Int. Cl. G06F 1/26

(52) U.S. Cl. 323/281

(57) ABSTRACT

A power supply adapter with USB connectors includes a housing with a plurality of USB connectors being exposed on the surface thereof, and a power supply device being provided in the housing. The power supply device is connected with an input power source and includes a load detection circuit for detecting if the USB connectors are connected with charged products, an overload protection circuit to protect the charged products from burning away due to an abnormal input voltage, an over voltage protection circuit to protect each circuit device from burning away due to a voltage too high, and a voltage level generation circuit for generating a potential difference which is afterwards introduced to the pin of the plural USB connectors during charging. The potential difference of the power source of a simulated computer host may be detected from the charged products and therefore the charged products can be smoothly charged.

### BACKGROUND OF THE INVENTION

1. Field of the Invention

This invention relates to a power supply device. Particularly, it relates to a power supply adapter with USB connectors, which generates a potential difference by means of a voltage level generation circuit, so that the potential difference of a power source of a simulated computer host is capable of being detected when a product is charged; therefore a smooth charge can be facilitated.

2. Description of the Prior Art

The electronic products such as PDA, MP3 and so forth are all required to be supplied power to operate normally, and the power source thereof is usually the battery. However, the power stored in the battery will run out sometime. The battery needs to be recharged once the power is used up. The power source of household, car, computer host and so forth may be used as the charge source of the battery. However, the adoption of the above power source in charging the battery is inherent with the following disadvantages:

1. In case that the household power source is used as the charge source, AC power source is required to be transformed into DC power source by the transformer at first. And then, the DC power source is output to the battery for storage. For the conventional transformer in charging is provided with no indicator of overload, it is easy for the charged product to be damaged.

2. In case that the car power source is used as the charge source, it is required to connect with the car power source by means of a car adapter, and then the car power source is output to the battery for storage. Conventionally, means for car charging is provided with no indicator of overload, it is easy for the charged product to be damaged.

3. In case that the computer host power source is used as the charge source, a USB connecting wire is required to output power to the battery for storage. Conventionally, means for charging by using the computer host power source is provided with no indicator of overload, it is easy for the charged product to be damaged. In addition, when some products to be charged is charged by means of a USB connecting wire, a detection is proceeded at first to see if there is any potential difference of the computer host data cable. In case of no potential difference, it is incapable of charging, with the result that the USB connecting wire can only be used for adapting the electronic product to the computer host.

Therefore, the conventional products with a lot of drawbacks are far from being a good design and needed to be improved.

In view of the above drawbacks of the conventional power supplying device, the inventor has focused his efforts for many years in the R&D of a novel and improved device thereof and eventually accomplished the present invention a power supply adapter with USB connectors.

### SUMMARY OF THE INVENTION

One object of the present invention is to provide a power supply adapter with USB connectors, wherein a power supply device is provided with a housing, and a plurality of USB connectors are formed on the surface of the housing, characterized in that the power supply device is connected with the transformer connecting wire, the connecting wire of the car power source connector or the USB connecting wire for the power source to be introduced to the plural USB connectors in the housing whereby the plural USB connectors can be used simultaneously for various types of electronic products to be charged.

Another object of the present invention is to provide a power supply adapter with USB connectors, which has a function of overload display to prevent the charged products from being damaged due to an abnormal voltage.

Still another object of the present invention is to provide a power supply adapter with USB connectors, which has a function of load display for the end user to easily be aware if the electronic products is being charged.

Yet still another object of the present invention is to provide a power supply adapter with USB connectors, which can generate a potential difference of the power source of a simulated computer host, whereby various types of electronic products may be charged by means of the USB connector.

To achieve the above objects of the present invention, a power supply adapter with USB connectors comprises a housing with a plurality of USB connectors and input holes of the power source being exposed on the surface thereof. Those input holes of the power source can be connected with various types of the power sources to introduce the power source to the power supply device. A power supply device is provided in the housing and includes a power input interface, an overload protection circuit, a load detection circuit, a load display, an over voltage protection circuit and a voltage level generation circuit. The power input interface is connected with the input holes of the housing to output the power to each circuit and introduce it to the plural USB connectors, whereby the plural USB connectors can output DC. The load detection circuit is used to detect if the plural USB connectors are connected with charged products, and a load display will illuminate, in case that there are connected with charged products. The overload protection circuit is used to protect the charged products from burning away due to an abnormal input voltage. The over voltage protection circuit is used to prevent each circuit device from being damaged for sake of the voltage too high; and the voltage level generation circuit can generate a potential difference which is afterwards introduced to the pin of the plural USB connectors such that during charging, a potential difference of the power source of a simulated computer host may be detected from the charged products and therefore the charged products may be smoothly charged.

These features and advantages of the present invention will be fully understood and appreciated from the following detailed description of the accompanying Drawings.

### BRIEF DESCRIPTION OF THE DRAWINGS

The drawings disclose illustrative embodiments of the present invention which serve to exemplify the various advantages and objects hereof, and are as follows:

FIG. 1 is a schematic prospective view of a power supply adapter with USB connectors according to the present invention;

FIG. 2 is a block of a power supply device of a power supply adapter with USB connectors according to the present invention;

FIG. 3 is a circuit diagram of a power supply device of a power supply adapter with USB connectors according to the present invention; and

FIGS. 4A, B, C are schematic views showing embodiments of a power supply adapter with USB connectors according to the present invention.

### DETAILED DESCRIPTION OF THE PREFERRED EMBODIMENT

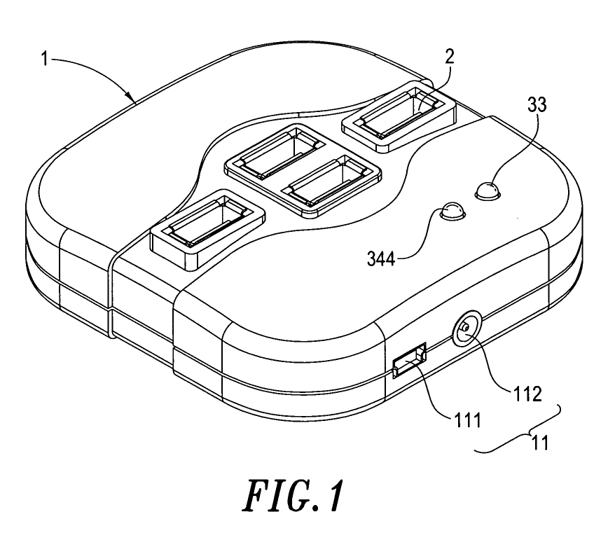

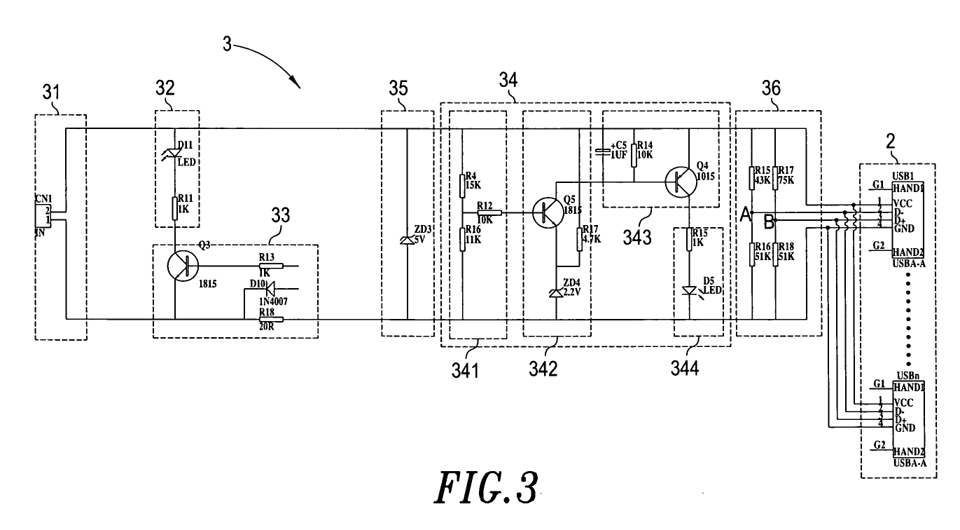

Referring to FIG. 1-3, a power supply burning away according to the present invention mainly comprises a housing 1 and a power supply device.

The housing 1 has a plurality of USB connectors 2 and input holes 11 of the power source being exposed on the surface of the housing 1. Those input holes 11 of the power source may be USB sockets 111 or plugging holes of the other form or specification.

The power supply device 3 is provided in the housing 1 and includes:

a power input interface 31, connecting with the input holes 11 of the housing 1 to output the input power to each circuit and the plural USB connectors, whereby the plural USB connectors can output DC;

a load detection circuit 32 for detecting if the plural USB connectors are connected with charged products, wherein a load display 33 projected out of the housing 1 will illuminate, in case that there are connected with charged products, the load display 33 being LED or the other illuminator;

an overload protection circuit 34 including a voltage sampling circuit 341, a voltage comparison circuit 342, an amplification circuit 343 and a display 344, wherein a power supplying voltage obtained by the voltage sampling circuit 341 is fed to the voltage comparison circuit 342 for comparison; and when the power supplying voltage is greater or equals to a predetermined value, the power supplying voltage is decided as normal; and afterwards, the signal thereof is amplified by the amplification circuit 343 to generate a current sufficient to illuminate the display 344; the display 344 projecting out of the housing 1 whereby the end user is easy to be aware if the charged products are kept normal in charging to prevent the charged products from being damaged; in addition, said display 344 being LED or the other illuminator; an over voltage protection circuit 35 which will proceed a voltage drop once the voltage is too high due to the input or the other reasons to prevent each circuit from being damaged for sake of the voltage too high; and a voltage level generation circuit 36 comprised of four resistors R15, R16, R17, R18 wherein resistors R15 and R16, R17 and R18 respectively connected in series are connected in parallel to the input power source, whereby the series connecting point A of resistors R15 and R16 and the series connecting point B of resistors R17 and R18 respectively generates a potential difference, and the potential difference on the point A and B are introduced to the pin D− and D+ of the plural USB connectors 2 such that there is a potential difference of the power source of a simulated computer host on the plural USB connectors 2.

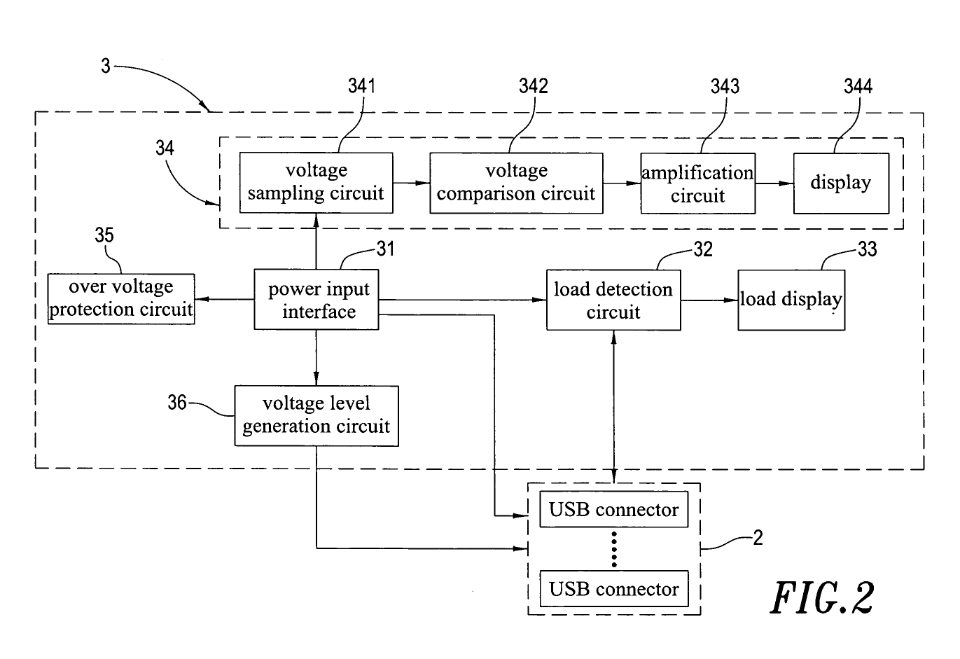

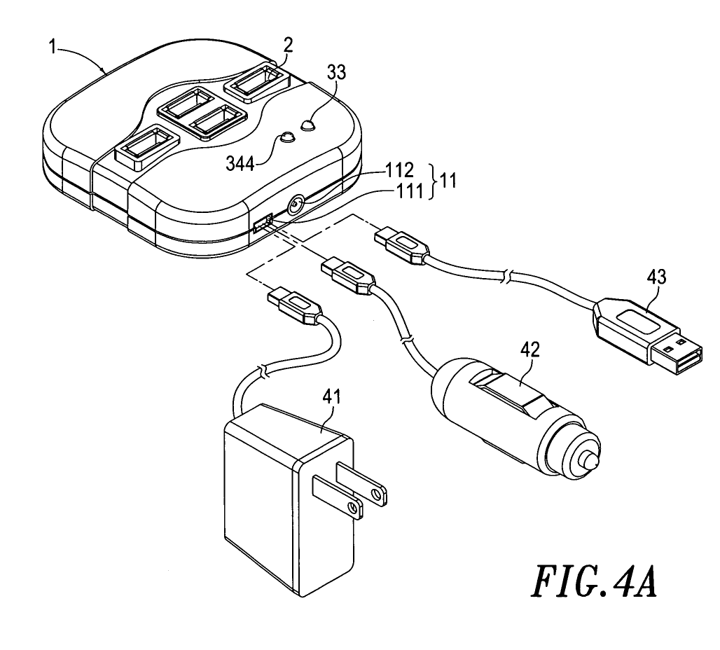

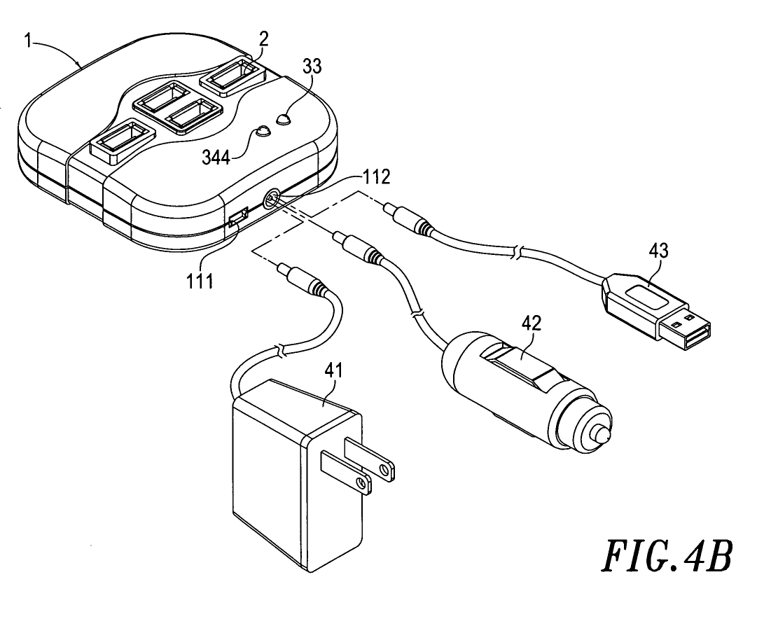

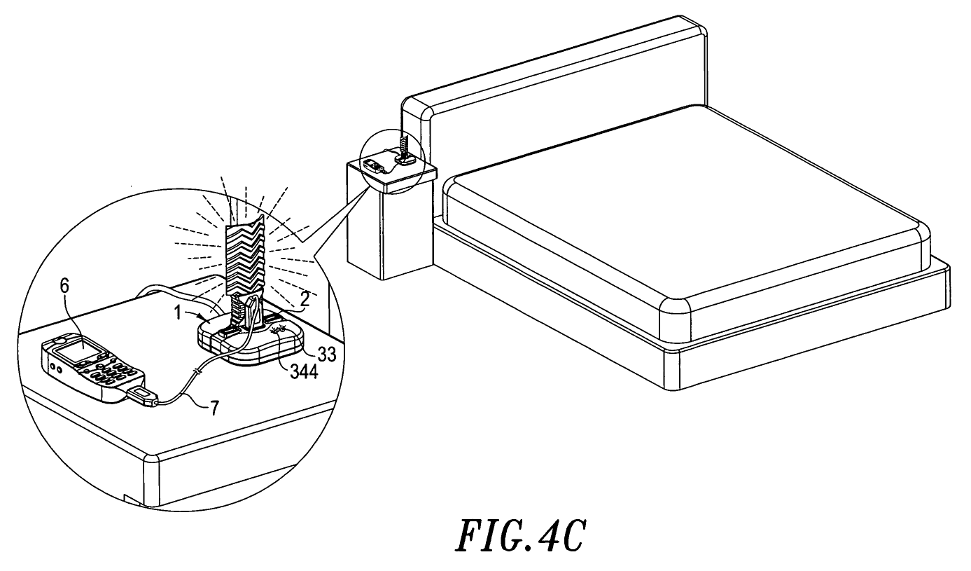

Now, please refer to FIG. 2 and FIGS. 4A, B, C schematically showing embodiments of the present invention. As FIGS. 4A, B shown, the end user may connect the power source to the input holes 11 of the housing 1 by means of a transformer connecting wire 41, a connecting wire 42 of the car power source connector or a USB connecting wire 43 for the power source to be introduced to the power input interface 31 of the power supply device 3 whereby the power may be fed by the power input interface 31 to the load detection circuit 32, the load display 33, the overload protection circuit 34, the over voltage protection circuit 35, the voltage level generation circuit 36 and the plural USB connectors 2, and therefore the USB connectors 2 may supply power to the charged products 6 or the electric products 5. Thus, various products may simultaneously be charged or turned on for use by means of the plural USB connectors 2 on the housing 1. When the electric products 5 or the charged products 6 are connected with the plural USB connectors 2 on the surface of the housing 1 through a USB connecting wire 7, load detection circuit 32 of the power supply device 3 will detect immediately if the electric products 5 or the charged products 6 is on the USB connectors 2. If the products are detected, the load display 33 will illuminate. And simultaneously, the overload protection circuit 34 will detect if the power supplying voltage is normal. If it is normal, the display 344 will illuminate for the end user to be aware that the charging condition is good.

Furthermore, while the charged products 6 is being charged, a potential difference of the power source of a simulated computer host will be detected, whereby those requiring a detection of the potential difference can be charged smoothly, and any type of the charged products may be charged by means of the plural USB connectors 2.

In comparison with the cited art, the power supply adapter with USB connectors provided by the present invention further has the following advantages:

1. As the present invention disclosed, a power supply device is provided in a housing, and a plurality of USB connectors are exposed on the surface of the housing, characterized in that the power supply device is connected with the transformer connecting wire, the connecting wire of the car power source connector or the USB connecting wire for the power source to be introduced to the plural USB connectors in the housing whereby the plural USB connectors can be used simultaneously for various types of charged products to be charged.

2. The present invention has a function of overload display to prevent the charged products from being burned away due to an abnormal voltage.

3. The present invention has a function of load display for the end user to easily be aware if the charged products is charged.

4. The present invention can generate a potential difference of the power source of a simulated computer host, whereby various types of charged products may be charged by means of the USB connector.

Many changes and modifications in the above described embodiment of the invention can, of course, be carried out without departing from the scope thereof. Accordingly, to promote the progress in science and useful arts, the invention is disclosed and is intended to be limited only by the scope of the appended claims.

What is claimed is:

1. A power supply adapter with USB connectors, comprising:
a housing, a plurality of USB connectors and input holes of the power source being formed on the surface of said housing; and
a power supply device, provided in said housing, including:
a power input interface, connecting with said input holes of said housing to output an input power to each circuit and said plural USB connectors;
a load detection circuit for detecting if said plural USB connectors are connected with charged products and a load display is illuminated;
an overload protection circuit for detecting if the power supplying voltage is normal, and a overload display is illuminated;
an over voltage protection circuit for detecting if the input voltage is too high to proceed a voltage drop; and
a voltage level generation circuit for generating a potential difference which is afterwards introduced to pins of said plural USB connectors such that there is a potential difference of the power source of a simulated computer host on said plural USB connectors.

2. A power supply adapter with USB connectors as claimed in claim 1, wherein said input hole of the power source is USB socket or plugging hole for the input power.

3. A power supply adapter with USB connectors as claimed in claim 1, wherein said overload protection circuit includes a voltage sampling circuit, a voltage comparison circuit, an amplification circuit and a display; and wherein a power supplying voltage obtained by said voltage sampling circuit is fed to said voltage comparison circuit for comparison; and when the power supplying voltage is greater or equals to a predetermined value, the power supplying voltage is decided as normal, and afterwards, the signal thereof is amplified by said amplification circuit to generate a current sufficient to illuminate the display.

4. A power supply adapter with USB connectors as claimed in claim 1, wherein said voltage level generation circuit is comprised of four resistors in which two pairs of resistors respectively connected in series are connected in parallel to said input power source, whereby the series connecting points respectively generate a potential difference, and the potential difference is introduced to pins of said plural USB connectors such that there is a potential difference of the power source of a simulated computer host on said plural USB connectors.
